(19) United States
(12) Patent Application Publication
(10) Pub. No.: US 2021/0088095 A1
(43) Pub. Date: Mar. 25, 2021

(54) DISK SPRING FOR AN EXHAUST GAS TURBOCHARGER

(71) Applicant: BMTS Technology GmbH & Co. KG, Stuttgart (DE)

(72) Inventors: Konrad Kissling, Stuttgart (DE); Anatolij Martens, Eislingen (DE)

(21) Appl. No.: 17/026,143

(22) Filed: Sep. 18, 2020

(30) Foreign Application Priority Data
Sep. 20, 2019 (EP) 19198652.0

(51) Int. Cl. F16F 1/32; F02C 6/12; F01D 25/16; F01D 25/14

(52) U.S. Cl. CPC F16F 1/32; F02C 6/12; F05D 2220/40; F01D 25/145; F01D 25/16

(57) ABSTRACT

A disk spring for an exhaust gas turbocharger is provided. The disk spring includes an annular base body extending around a central longitudinal axis and along a circumferential direction of the disk spring and enclosing a disk opening. Preload elements are formed on an inner circumference of the base body for exerting a preload force on a mounting section of an exhaust gas turbocharger inserted into the disk opening.

### CROSS REFERENCE TO RELATED APPLICATIONS

This application claims priority to European patent application EP 19198652.0, filed Sep. 20, 2019, the entire content of which is incorporated herein by reference.

### TECHNICAL FIELD

The disclosure relates to a disk spring for an exhaust gas turbocharger and an exhaust gas turbocharger for an internal combustion engine with such a disk spring.

### BACKGROUND

A disk spring is often used to axially pre-tension the guide vane carrier of a variable turbine geometry (VTG) of an exhaust gas turbocharger. This spring is usually also used as a heat shield to thermally shield the VTG rear chamber from the turbine chamber of the exhaust gas turbocharger.

However, engine vibrations can cause the axially pre-tensioned disk spring or heat shield to move relative to the bearing housing and the guide vane carrier of the exhaust gas turbocharger, which can lead to wear, especially on the contact surface of the bearing housing due to the higher surface pressure and lower material grades present there. Particularly in high-temperature applications with exhaust gas temperatures in the range of 1000° C. or more, as found in current gasoline engines, the effect of heat may cause the disk spring or heat shield to relax, which in turn may lead to movement of the disk spring or heat shield relative to the bearing housing or the guide vane carrier and thus to wear on the contact surfaces. This in turn can cause a reduction in the spring tension generated by the disk spring if there is sufficient wear.

For mounting on the bearing housing, the heat shield must be placed on the bearing housing before the shaft of the exhaust gas turbocharger is mounted on the bearing housing and must therefore not fall off the bearing housing or hang at an angle and thus come into contact with the turbine wheel when balancing the shaft mounted on the bearing housing—the VTG and the and turbine housing are not yet mounted at this time. For this reason, the disk opening of the disk spring is usually dimensioned in such a way that it is placed on a lug provided on the bearing housing—also referred to in the following as the mounting section—and is sufficiently held by this lug so that the disk spring acting as a heat shield cannot tilt as desired or can tilt only slightly without the disk spring acting as a heat shield coming into contact with the rotating turbine wheel during the balancing process.

In order to counteract a loss of pretension of the heat shield at high temperatures, a functional separation of shielding plate and disk spring can be made as described, e.g., in DE 10 2018 218 395.

Furthermore, the stress distribution in the disk spring can be optimized by shaping it as described in DE 10 2018 210 022 such that the disk spring is less susceptible to high temperatures.

DE 10 2012 208 044 A1 proposes a non-circular shape of the heat shield, which prevents the heat shield from twisting.

From U.S. Pat. No. 8,376,721 B2, a heat protection plate is known to be caulked with the bearing housing so that a relative movement to the bearing housing is avoided.

DE 10 2015 219 656 A1 discloses a heat shield that is centered in an area centrally between its outer and inner circumference over three contact surfaces.

DE 10 2015 220 113 A1 discloses a heat shield that has an external thread protruding from the bearing housing on its inner circumference, with which the heat shield is screwed into the bearing housing.

CN 204 402 584 U discloses a heat shield that is axially fixed with a mounting ring that engages radially in the bearing housing.

However, the non-round shape revealed in DE 10 2012 208 044 A1 is quite complex from a production point of view and therefore expensive to produce. In addition, the shape cannot successfully prevent the bearing from slipping off the bearing housing.

The multi-curved disk spring known from DE 10 2018 210 022 is very robust at high temperatures, but has the disadvantage that, due to the increasingly compact design of modern exhaust gas turbochargers, it can only be held inadequately by the lug provided on the bearing housing during the assembly and balancing process, which can lead to problems when balancing the runner if the heat shield detaches from its target position during the balancing process and touches the turbine wheel. This ultimately has a negative effect on the balancing quality.

The solution known from DE 10 2018 218 395 is also very robust against high temperatures but has the same disadvantages as DE 10 2018 210 022 and is also much more expensive to produce because it uses two components instead of one.

Caulking of the heat shield with the bearing housing—as known from U.S. Pat. No. 8,376,721 B2—is relatively complex from a production point of view, since a further production step, in particular an additional tool, is required. However, this design has the advantage that slippage of the heat protection plate during assembly or operation can be ruled out.

The centering of the heat shield described in DE 10 2015 219 656 is only used for positioning, not for fixing the heat shield, so that it can continue to come loose during the balancing process. With regard to clamping force, a position as far inside as possible is most favourable, as the influence of thermal expansion of the bearing housing is least significant here due to the small radius.

Fixing the heat shield with a thread is unnecessarily expensive from a manufacturing point of view, since threads must first be cut on both the heat shield and the bearing housing before assembly.

The solution with the mounting ring described in CN 204402584 U also requires an additional component, which produces unnecessary costs and complicates assembly.

### SUMMARY

It is therefore a problem, the present disclosure faces, to create a disk spring usable as a heat shield, which can be mounted on the bearing housing in a particularly simple and thus cost-effective manner, but at the same time is sufficiently held on the mounting section of the bearing housing of an exhaust gas turbocharger such that it does not leave its desired position on the bearing housing either during the mounting process of the exhaust gas turbocharger or during operation of the exhaust gas turbocharger under the influence of high thermal loads.

This problem is solved by a disk spring for an exhaust gas turbocharger and an exhaust gas turbocharger as described herein.

The basic idea of the disclosure is therefore to provide an annular disk spring to be used as a heat shield in an exhaust gas turbocharger with radially inwardly projecting projections on the inner circumference along the circumferential direction, which are bent axially away from a central longitudinal axis of the disk spring. In this way, preloading elements are created with which the disk spring can be clamped onto a mounting section provided on the bearing housing of the turbocharger. With the preload force generated by the preload elements, the disk spring can be held stably on the bearing housing even under the influence of vibrations and thermal expansion, such as occur during operation of the exhaust turbocharger in a motor vehicle.

The optimum number of preload elements to be provided results from the spring preload required to adequately fix the disk spring to the bearing housing even under thermal load and, in particular, to center it radially.

A disk spring for an exhaust gas turbocharger according to the disclosure comprises an annular base body extending around a central longitudinal axis and along a circumferential direction of the disk spring and enclosing a disk opening. Preload elements are formed on an inner circumference of the base body for exerting a preload force on a mounting section of an exhaust gas turbocharger which is inserted/slid into the disk opening.

According to an exemplary embodiment, at least one preload element is formed by a projection projecting radially inwards on the inner circumference of the base body and bent away from the central longitudinal axis. This means that the radial distance of the bent projection from the central longitudinal axis is increased compared to a non-bent projection. However, with respect to the orientation of the projection opposite the central longitudinal axis, which extends along an axial direction, the projection is bent towards the central longitudinal axis, i.e., an intermediate angle between the bent projection and the central longitudinal axis is reduced compared to an intermediate angle between the unbent projection and the central longitudinal axis. Such a realization of the preload elements is technically easy to realize, such that cost advantages arise in the production of the disk spring according to the disclosure. Therefore, all preload elements of the disk spring are designed in particular preference as described above.

According to another exemplary embodiment, the at least one preload element or the at least one projection is designed or bent over in such a way that the preload force it generates acts in a radial direction of the disk spring which extends orthogonally away from the central longitudinal axis. In this way, the disk spring can be fixed mechanically in a particularly stable manner to the bearing housing of the turbocharger. In addition, precise radial centering of the disk spring and thus of the heat shield on the—typically lug- or bolt-like—mounting section of the bearing housing can be achieved.

According to an advantageous further exemplary embodiment, at least one recess is designed as a slot-like opening extending in the radial direction of the disk spring. Such a slot-like opening can be produced by a simple punching process. In addition, the opening has only a small width in the circumferential direction, such that a large number of preload elements can be realized along the circumferential direction on the inner circumference of the base body.

It is useful to have a radially inner end portion of at least one projection extending parallel to the central longitudinal axis in a longitudinal section along the central longitudinal axis. This results in a sleeve-shaped section of the disk spring, which can be brought into contact with the mounting section of the bearing housing on the inner circumference. This improves the stability of the fastening.

Typically, the base body can be designed as a sheet metal part with a predetermined sheet thickness. Such a shaped sheet metal part is particularly easy to machine, especially to form. In particular, it is easy to bend over the projections projecting inwards on the inner circumference to form the preload elements.

A portion length, measured along the axial direction, of the bent radially inner end portion extending parallel to the central longitudinal axis is particularly typical to be at least two, typically at least three, and at most ten, most typically at most five sheet thicknesses of the base body formed as a sheet metal part. This ensures that the base body also has the necessary mechanical rigidity in the area of the preload elements or projections and that the surface pressure generated by the preload can be kept low.

In the longitudinal section along the central longitudinal axis, the radially inner end portion —to form a contact surface for the exhaust gas turbocharger—merges particularly preferentially radially outwards into a contact portion that extends perpendicular to the central longitudinal axis, i.e., along the radial direction. In this way, the main body of the disk spring can be fixed axially, mechanically stable and precisely to the bearing housing of the turbocharger.

The preload elements or the projections can be formed integrally on the base body. This variant has proven to be particularly easy to manufacture and therefore cost-effective.

Typically, the base body can be designed rotationally symmetrical to the central longitudinal axis without preload elements. This variant is also technically very easy to implement and therefore also very cost-effective.

According to another exemplary embodiment, in the longitudinal section along the central longitudinal axis, the base body and the preload elements or the projections together form an S-shaped geometry. Advantageously, this allows for generating a preload force acting radially as well as axially with particularly little peaks of the mechanical tension that present in the disk spring in its mounted state.

In another exemplary embodiment, exactly three preload elements or projections are provided, which are arranged equidistantly to one another along the circumferential direction. Therewith, self-centering effects as to center the disk spring relatively to the mounting section of the exhaust gas turbocharger can be achieved, which enable a reduction of assembly effort and thus may reduce costs. Additionally, similar to the tripod principle the preload force generated by each of the preload elements or projections can distributed particularly evenly among said preload elements or projections automatically.

The disclosure also concerns an exhaust gas turbocharger, in particular for an internal combustion engine. The exhaust gas turbocharger comprises a turbine which has a turbine housing and a turbine wheel accommodated in the turbine housing. The exhaust gas turbocharger further comprises a disk spring according to the disclosure as presented above, so that the advantages of the disk spring are transferred to the exhaust gas turbocharger according to the disclosure. Further, the exhaust gas turbocharger according to the disclosure comprises a bearing housing having a mounting portion which passes through the disk opening so that the disk spring is fixed to the bearing housing to form a heat shield which, during operation of the exhaust gas turbocharger, shields the bearing housing from heat generated by the turbine.

According to an exemplary embodiment, the preload elements lie flat against the mounting section of the bearing housing. In this way, the disk spring is fixed to the bearing housing almost or completely without tilting.

The preload elements formed on the base body exert a preload force on the mounting section of the bearing housing with particular preference. In this way, the disk spring is firmly fixed to the bearing housing.

In particular, the preload force generated by the preload elements and exerted on the mounting section of the bearing housing acts essentially in the radial direction of the disk spring. In this way, the fixing effect achieved by the preload elements can be maximized.

The disk spring with its radially outer end portion of the base body is particularly typical to lie axially against a guide vane carrier of the exhaust gas turbocharger, so that the disk spring pretensions the guide vane carrier axially towards the turbine housing. In this way, the guide vane carrier is firmly fixed to the turbine housing.

Further important features and advantages of the disclosure result from the drawings and from the corresponding figure description based on the drawings.

It goes without saying that the features mentioned above and those to be explained below can be used not only in the combination indicated in each case, but also in other combinations or on their own, without leaving the scope of the present disclosure.

Exemplary embodiments of the disclosure are shown in the drawings and are explained in more detail in the following description, whereby identical reference signs refer to identical or similar or functionally identical components.

### BRIEF DESCRIPTION OF THE DRAWINGS

The disclosure will now be described with reference to the drawings wherein:

FIG. 1 shows a disk spring in a cross-section perpendicular to the central longitudinal axis of the disk spring according to an exemplary embodiment of the disclosure,

FIG. 2 shows the disk spring shown in FIG. 1 in a longitudinal section along the central longitudinal axis,

FIG. 3 shows a detailed representation of the disk spring of FIG. 2 in the area of a preload element,

FIG. 4 shows the disk spring shown in FIG. 2 with an additional heat shield according to a further exemplary embodiment of the disclosure,

FIG. 5 shows a schematic partial representation of an exhaust gas turbocharger with the disk spring shown in FIGS. 1 to 3 mounted on the bearing housing of the exhaust gas turbocharger according to an exemplary embodiment of the disclosure, and

FIG. 6 shows the exhaust gas turbocharger according to FIG. 5 with the disk spring according to FIG. 4.

### DESCRIPTION OF EXEMPLARY EMBODIMENTS

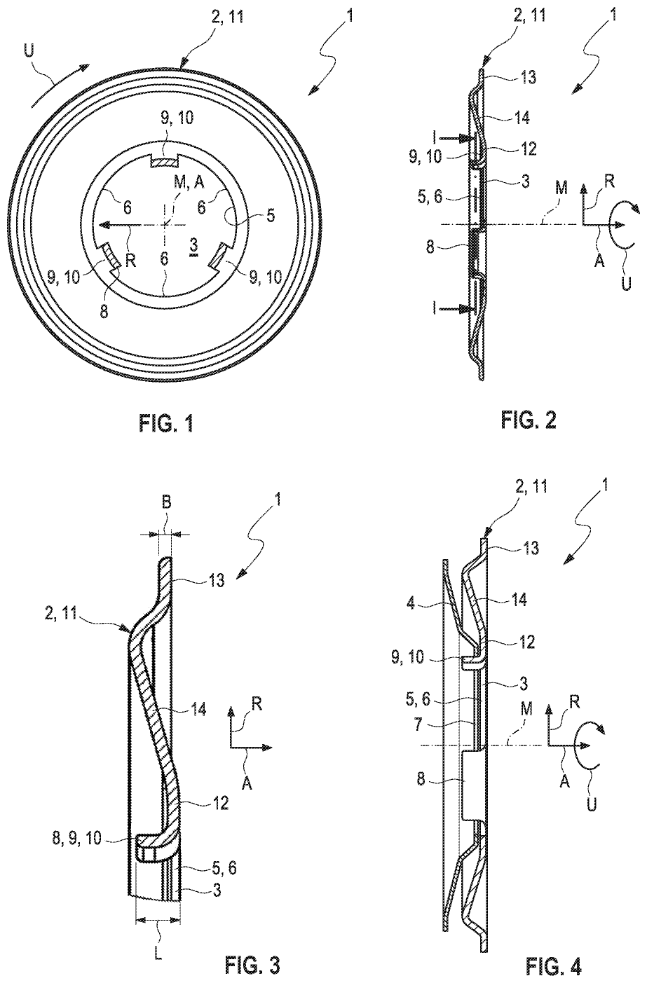

FIG. 1 shows an example of a disk spring 1 according to an exemplary embodiment of the disclosure in a cross-section perpendicular to a central longitudinal axis M of disk spring 1, FIG. 2 in a longitudinal cross-section along this central longitudinal axis M. FIG. 1 shows the disk spring 1 along the section line I-I of FIG. 2. For use as a heat shield, the disk spring 1 is usually made of heat-resistant steels, nickel or cobalt alloys, which even above a temperature of 800° C. still have well over fifty percent of their yield strength.

According to FIGS. 1 and 2, disk spring 1 comprises an annular base body 2, which extends along a circumferential direction U of disk spring 1 around the central longitudinal axis M, which in turn extends along an axial direction A. The circumferential direction U extends perpendicular to the axial direction A and revolves around the central longitudinal axis M. A radial direction R extends orthogonally away from the central longitudinal axis M and also extends perpendicular to both the axial direction A and the circumferential direction U.

As can be seen in FIG. 1, on an inner circumference 5 of the ring-shaped base body 2, which encloses and radially limits the disk opening 3, preload elements 10 are formed to exert a preload force on a mounting section (not shown in FIG. 1) of an exhaust gas turbocharger inserted into the disk opening 3. The preload elements 10 are formed by projections 9 projecting radially inwards on the inner circumference 5.

In the example of FIG. 1, three preload elements 10 or three projections 9 are shown, which are arranged at a distance from each other along the circumferential direction U. In variants of the example, a different number of preload elements 10 or projections 9 may be provided. The preload elements 10 or the projections 9 are integrally formed on the base body 2; the preload elements 10 or the projections 9 and the base body 2 are therefore formed in one piece and of the same material.

As FIG. 1 illustrates, the base body 2 is rotationally symmetrical to the central longitudinal axis M without the preload elements 10 or the projections 9.

In the cross-section perpendicular to the central longitudinal axis M shown in FIG. 1, a recess 6 is formed between each two adjacent preload elements 10 or projections 9 in the circumferential direction U. The recesses 6 can typically be designed as slot-like openings extending in the radial direction R of the disk spring 1 (not shown).

According to FIG. 2, in the longitudinal section along the central longitudinal axis M the projections 9 are bent away from the central longitudinal axis M. Thus, the preload elements 10 or projections 9 can each generate a preload force acting in the radial direction R. It is further to be seen from FIG. 2 that in the longitudinal section along the central longitudinal axis M, the base body 2 and the preload elements 10 or the projections 9 together form an S-shaped geometry.

According to FIGS. 2 and 3—the latter being a detailed representation of FIG. 2 in the area of the inner circumference 5—in the longitudinal section along the central longitudinal axis M, a radially inner end portion 8 of the respective projection 9 extends parallel to the central longitudinal axis M.

The base body 2 can be designed as a sheet metal part 11 with a predetermined sheet thickness B. A section length 1, measured along the axial direction A, of the radially inner end portion 8 extending parallel to the central longitudinal axis M is at least two sheet thicknesses B, preferably at least three sheet thicknesses B.

As FIG. 3 furthermore illustrates, in the longitudinal section shown, along the central longitudinal axis M, the radially inner end portion 8 for forming a contact surface for the turbocharger merges radially outwards into a contact portion. This contact portion 12 extends along the radial direction R and thus perpendicular to the central longitudinal axis M. The contact portion 12 merges radially outwards into a central portion 14, which may be arranged at an acute angle to the central longitudinal axis M in the longitudinal section of FIG. 2. The central portion 14 again merges radially outwards into a radially outer end portion 13.

Preload elements 10 or bent projections 9 and recesses 6 are arranged equidistantly to each other on the inner circumference 5 with respect to the circumferential direction U, i.e., two adjacent recesses 6 along the circumferential direction U and also two adjacent projections 9 along the circumferential direction U are arranged at a uniform, i.e. the same, distance from each other.

FIG. 4 shows a further exemplary embodiment of the example of FIG. 3. In the exemplary embodiment of FIG. 4 the disk spring 1 comprises an additional annular heat shield 4, which is arranged axially adjacent to the base body 2 of the disk spring 1 and rests axially on the contact portion 12 of the disk spring 1. In particular, the additional heat shield 4 may have a heat shield opening 7 into which the radially inner end portion 8 of the disk spring 1 is inserted. In this way, the heat shield 4 and the base body 2 are firmly fixed together. The additional heat shield 4 and the main body 2 are thus designed in two parts.

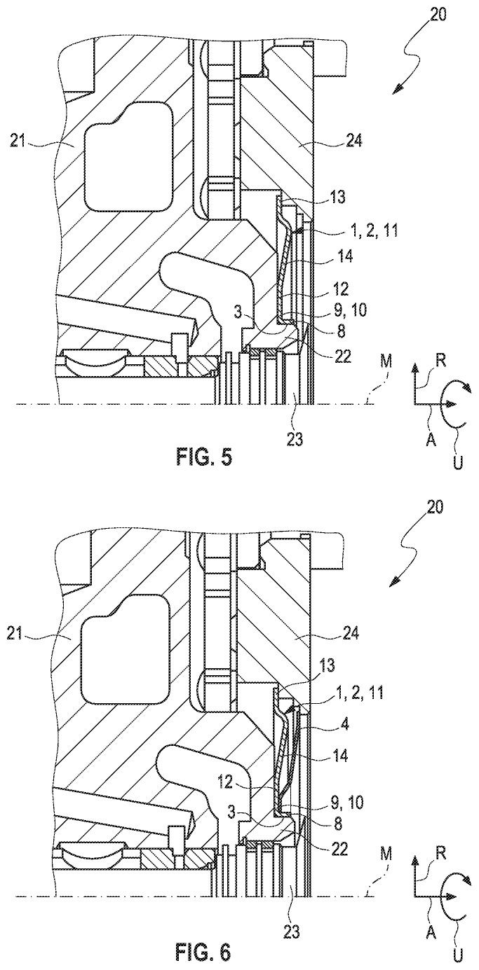

FIG. 5 illustrates the use of the disk spring 1 according to FIGS. 1 to 3 as explained above in an exhaust gas turbocharger 20 for an internal combustion engine. The exhaust gas turbocharger 20 comprises a turbine which has a turbine housing and a turbine wheel (not shown) accommodated in the turbine housing. The exhaust gas turbocharger 20 further comprises a disk spring 1 as explained above, which is in accordance with the disclosure. The exhaust gas turbocharger 20 also comprises a bearing housing 21, which has a mounting section 22 for fastening the disk spring 1. In the state of the disk spring 1 mounted in the turbocharger 20, as shown in FIG. 4, the mounting section 22—typically of bolt-like design—passes through the disk opening 3.

The preload elements 10 formed on the base body 2 or the bent projections 9 rest flat against the mounting section 22 of the bearing housing 21 and exert a preload force acting in radial direction R on the mounting section 22 of the bearing housing 21. In this way the disk spring 1 is fixed to the mounting section 22 of the bearing housing 21.

As shown in FIG. 5, the disk spring 1 is located between the turbine housing and bearing housing 21. Thus, the disk spring 1 can act as a heat shield, shielding the bearing housing 21 and components of the exhaust gas turbocharger 20 located behind the bearing housing 21—this includes in particular components that are part of the compressor (not shown) of the exhaust gas turbocharger 20—against heat generated in the turbine during operation of the exhaust gas turbocharger 20.

In particular, the disk spring 1 as shown in FIG. 5 with the radially outer end portion 13 of the base body 2 is in axial contact with a guide vane carrier 24 of the exhaust gas turbocharger 20, so that the disk spring 1 pretensions the guide vane carrier 24 axially to the turbine housing. In this way, the guide vane carrier 24 is firmly fixed to the turbine housing.

In the course of the assembly of the exhaust gas turbocharger 20, the disk spring 1 is first placed on the typically nose-shaped mounting section 22 provided on the bearing housing in a force-locking manner, so that the mounting section 22 then passes through the disk spring 1.

Then the shaft 23 of the exhaust gas turbocharger can be inserted from the turbine side into the bearing lane of the bearing housing 21 and then the compressor wheel can be mounted on the compressor side. After the assembly of this body arrangement is completed, it is balanced with the assembled shaft 23.

FIG. 6 shows a further exemplary embodiment of the exhaust gas turbocharger 20 of FIG. 4, in which the disk spring 1 shown in FIG. 4 is used with an additional heat shield 4. In this example, the disk spring 1 is arranged along the axial direction A between the bearing housing 21 and the additional heat shield 4.

It is understood that the foregoing description is that of the exemplary embodiments of the disclosure and that various changes and modifications may be made thereto without departing from the spirit and scope of the disclosure as defined in the appended claims.

What is claimed is:

1. A disk spring for an exhaust gas turbocharger, the disk spring comprising:
an annular base body extending around a central longitudinal axis and along a circumferential direction of the disk spring and enclosing a disk opening,
wherein preload elements are formed on an inner circumference of the base body for exerting a preload force on a mounting section of an exhaust gas turbocharger inserted into the disk opening.

2. The disk spring according to claim 1, wherein at least one preload element, typically all preload elements, is/are formed by an projection projecting radially inwards on the inner circumference of the base body and bent over away from the central longitudinal axis.

3. The disk spring according to claim 1, wherein the at least one preload element or the at least one projection is formed or bent over in such a way that the preload force generated by it acts in a radial direction of the disk spring which extends orthogonally away from the central longitudinal axis.

4. The disk spring according to claim 1, wherein in a cross-section perpendicular to the central longitudinal axis, typically also in a plan view of the base body along the central longitudinal axis, at least two, typically several, preload elements or projections are arranged at a distance from one another on the inner circumference along the circumferential direction.

5. The disk spring according to claim 1, wherein in the cross section perpendicular to the central longitudinal axis a recess is formed between two adjacent preload elements or projections with respect to the circumferential direction.

6. The disk spring according to claim 5, wherein at least one recess is formed as a slot-like opening extending along the radial direction of the disk spring.

7. The disk spring according to claim 2, wherein in the longitudinal section along the central longitudinal axis, a radially inner end portion of at least one projection extends parallel to the central longitudinal axis.

8. The disk spring according to claim 1, wherein the base body is formed as a shaped sheet metal part with a predetermined sheet thickness.

9. The disk spring according to claim 8, wherein an axially measured section length of the radially inner end portion extending parallel to the central longitudinal axis is at least two, typically at least three and at the most ten, most typically at the most five sheet thicknesses.

10. The disk spring according to claim 7, wherein in the longitudinal section along the central longitudinal axis, the radially inner end portion—to form a contact surface for the exhaust gas turbocharger—merges radially outwards into a contact portion which extends perpendicularly to the central longitudinal axis.

11. The disk spring according to claim 1, wherein the preload elements or the projections are integrally formed on the base body.

12. The disk spring according to claim 1, wherein the base body without the preload elements is designed rotationally symmetrical to the central longitudinal axis.

13. The disk spring according to claim 1, wherein in the longitudinal section along the central longitudinal axis, the base body and the preload elements or the projections together form an S-shaped geometry.

14. The disk spring according to claim 1, wherein exactly three preload elements or projections are provided, which are arranged equidistantly to one another along the circumferential direction.

15. An exhaust gas turbocharger, comprising:
a turbine which has a turbine housing and a turbine wheel accommodated in the turbine housing,
a disk spring according to claim 1,
a bearing housing which has a mounting section which passes through the disk opening of the disk spring, such that the disk spring is fixed to the bearing housing for forming a heat shield which, during operation of the exhaust gas turbocharger, shields the bearing housing against heat generated by the turbine.

16. The exhaust gas turbocharger according to claim 15, wherein the preload elements formed on the base body exert a preload force on the mounting section of the bearing housing.

17. The exhaust gas turbocharger according to claim 15, wherein the preload force generated by the preload elements and exerted on the mounting portion of the bearing housing acts substantially in the radial direction of the disk spring

18. The exhaust gas turbocharger according to claim 15, wherein the preloading elements lie flat against the mounting section of the bearing housing.

19. The exhaust gas turbocharger according to claim 15, wherein the disk spring with a radially outer end portion of the base body bears axially against a guide vane carrier of the exhaust gas turbocharger, such that the disk spring pretensions the guide vane carrier axially to the turbine housing.
